(19) United States
(12) Patent Application Publication
(10) Pub. No.: US 2016/0279829 A1
(43) Pub. Date: Sep. 29, 2016

(54) APPARATUS AND PROCESS FOR GRANULATING MOLTEN MATERIAL

(71) Applicant: MAAG AUTOMATIK GMBH, Grossostheim (DE)

(72) Inventors: Stefan Deiss, Harxheim (DE); Burkard Kampfmann, Mombris (DE); Reinhardt-Karsten Murb, Aschaffenburg (DE)

(21) Appl. No.: 15/174,755

(22) Filed: Jun. 6, 2016

Related U.S. Application Data
(63) Continuation of application No. PCT/EP2014/003230, filed on Dec. 3, 2014.

(30) Foreign Application Priority Data
Dec. 5, 2013 (DE) 102013020317.1
Dec. 3, 2014 (EP) PCT/EP2014/003230

(51) Int. Cl. B29B 9/06; B01J 2/20

(52) U.S. Cl. CPC B29B 9/065; B01J 2/20

(57) ABSTRACT

A device and method for producing pellets from a melt material, the device having a perforated plate with nozzles. Located opposite the perforated plate is a cutter arrangement having a cutter head with at least one blade, wherein the device additionally has a cutting chamber in a housing. A coolant is introduced into the cutting chamber from an inlet apparatus, wherein one or more additional feed opening(s) is/are provided for an additional flow of coolant to the cutting chamber. The additional coolant flows at least in the area of rotation of the at least one blade, circumferentially at least in sections, with an orientation such that this additional flow of coolant differs from the flow of coolant entering through the inlet nozzle arrangement in at least one of the following parameters: physical state, direction, speed, pressure, temperature, density, throughput rate, and/or composition.

### CROSS REFERENCE TO RELATED APPLICATIONS

The present patent application is a Continuation that claims priority to and the benefit of co-pending International Patent Application No. PCT/EP2014/003230 filed Dec. 3, 2014, entitled “APPARATUS AND PROCESS FOR GRANULATING MOLTEN MATERIAL”, which claims priority to DE Application No. 102013020317.1 filed Dec. 5, 2013. These references are hereby incorporated in their entirety.

### FIELD

The present embodiments generally relate to a device for granulating melt material.

### BACKGROUND

The invention relates to a device for granulating melt material, for example from a material or material mixture with an active pharmaceutical ingredient or, for example a plastic melt material such as a polymer melt material. The material is granulated into pellets, such as for manufacturing pharmaceutical products from a corresponding melt material.

Melt material in general today is often processed and treated through granulation. Generally speaking, extruders or melt pumps are frequently used in the granulation of melt material, such as plastics. These extruders or melt pumps press molten plastic raw material through nozzles of a perforated plate into a coolant such as water. In this process, the material emerging through the openings of the nozzles is cut by a cutter arrangement with at least one rotating blade in order to produce pellets. Corresponding devices, which carry out methods for underwater granulation, for example, are known as underwater granulators, such as those sold under the product name SPHERO® from the firm Automatik Plastics Machinery GmbH.

Systems for carrying out air-cooled hot die-face pelletization in air as the coolant have been on the market for quite a long time, and are well known to persons having ordinary skill in the art since they represent relatively easy-to-build machines for granulating extruded thermoplastics. In these machines, strands of melt emerging from the perforated plate are chopped by blades rotating as closely as possible to the surface, and are formed into pellets by the inertia inherent in the small pieces of strand material. As a result of the rotation of the blades, air is drawn in from the environment or the interior of the housing, and the air directs the pellets more or less freely and centrifugally away from the cutting location.

Generally speaking, in granulation using the air-cooled hot die-face pelletizing method, a molten polymer matrix can be pressed through an arrangement of one nozzle or multiple nozzles terminating in a flat surface over which passes a cutter arrangement consisting of one or more blades. The emerging strand is cut by the blade or blades into small units, so-called pellets, each of which is initially still molten.

The problems that occur in these systems are typically due to the poor cooling of the blades, which over the course of time can overheat and stick, as well as the tendency toward general sticking and clogging of such systems, especially at high throughput rates with large quantities of pellets to be produced under real production conditions.

Furthermore, pellets produced in this way tend to have cylindrical and irregular shapes, especially when the viscosity of the melt material is relatively high, whereas in the case of pharmaceutical materials in particular, a great many spherical pellets of uniform size are more likely to be required in the downstream applications.

Subsequently the pellets are brought to below the solidification temperature of the polymer matrix by cooling, so that they solidify and in doing so, lose the inherent stickiness of the melt and the tendency to adhere to a surface or one another. In accordance with the prior art, a further subdivision is made here into methods and machines employing these methods that use water or a similar liquid as coolant, known as underwater hot die-face pelletizing, and those known as air-cooled hot die-face pelletizing, which is to say the methods and machines in which cooling after cutting is initially accomplished with the exclusion of a liquid medium using gas alone (preferably air), or with a mist consisting of a mixture of a gas and droplets of a liquid.

The latter group is further differentiated by the type of additional cooling method that is downstream in terms of processing, namely methods and machines in which a water film flows over the wall of the cutting chamber, which has a more or less cylindrical to truncated conical shape, into which the pellets drop and are transported out of the cutting device. These are also referred to as water ring pelletizers.

However, if products are to be granulated for which contact with water is undesirable, granulators are used in which the freshly cut, still molten pellets are cooled exclusively by the cooling and transport gas. It is nonetheless typical for machines corresponding to the prior art, that firstly, the freshly cut pellets are accelerated radially outward by the centrifugal force of the cutter arrangement, and secondly, that the cooling process proceeds relatively slowly, and hence the pellet must travel a relatively long distance in free flight before being allowed to come into contact with a surface.

As a result, such granulators are very large, even for low throughputs. The size and the low coolant gas flow rate relative thereto result in the occurrence of internal turbulence, causing a portion of the pellets to come into contact with the housing parts and other machine parts too soon, where they can stick. Moreover, ambient air is typically drawn in as the coolant gas, which itself can already be laden with dust and undesirable substances, and for which it is difficult if not impossible to monitor the properties of temperature, moisture content, and dust content.

In order to achieve operation of a granulating system that is as trouble-free as possible, it would be desirable for the pellets to cool sufficiently rapidly that they already have a solidified surface before they come into contact with housing or cutter parts or with other pellets. The cooling rate is primarily a function of the temperature difference and secondarily a function of the rapid exchange of volume elements of the gas with one another, which is referred to in the technical field as the degree of turbulence. The Reynolds number can be used as the parameter for the degree of turbulence.

In this context, the cooling effect depends primarily on the properties of the polymer melt (specifically temperature, thermal capacity, surface, thermal conductivity, particle size, and specific surface) and of the coolant gas itself (specifically temperature, thermal capacity, degree of turbulence, coolant gas/polymer pellet mass flow ratio). Most of these factors are either material constants or parameters determined by the process technology, so only a few possibilities exist for influencing the intensity of the cooling effect. In the final analysis, the heat content of the polymer pellets must be transferred to the coolant gas. If heat exchange with the housing parts and other machine parts is disregarded, the heat content difference in the melt material is equal to the heat content difference in the coolant gas.

The abovementioned SPHERO® line from the firm Automatik Plastics Machinery GmbH has, under the designation THA, a granulating device with a cooling and transport air supply which directs the cooling and transport air through an adjustable gap that encircles the perforated plate and is aimed at a hole circle of nozzles, and onto the hole circle. As a result, the cooling and transport air flow is directed exactly at the location where the melt to be granulated, which has been heated to a temperature appreciably above the melting point or the softening range, emerges from the shape-providing nozzle openings and is reduced to granules by the rotating blades.

As this occurs, the surface of the granules being created should be cooled down sufficiently that the inherent stickiness of the typical materials in the molten state is suppressed as much as possible and, due to the inherent increase in viscosity, likewise of the typical materials when the temperature is lowered, particularly in the range just above the melting point, is solidified, at least at the surface and in layers near the surface of the granules, sufficiently that the freshly produced granule largely maintains its shape as it is carried away by the cooling fluid in the form of cooling and/or transport air.

At the same time, the surface of the perforated plate is cooled in the region of the blades passing in circles over its surface, and the frictional heat introduced by the blades passing in circles over the surface is at least partially removed, and consequently any adhesion of a melt film forming between the surface of the perforated plate and the blades contacting the surface of the perforated plate and passing in circles over it during cutting of the granules being formed is largely prevented.

If the cooling action of the volume of air directed through the annular shape-providing nozzle bores at the circular arrangement is too intensive however, this can have the effect that the perforated plate is cooled down too far at the surface and in the layers near the surface, thus causing the melt flowing in from the hot region behind the perforated plate to be cooled below the melting point or the softening range, and consequently to harden even before exiting the shape-providing nozzle bores, thus clogging or blocking the flow channels.

This problem can be counteracted by raising the temperature of the cooling fluid, although the risk then exists that either the surface of the granules is no longer cooled sufficiently below the temperature threshold above which the surface becomes sticky, which can have the subsequent result that granules adhere to one another and to the internal surfaces of the granulator, which can impede the production of granules or disrupt the production process.

Another method for preventing freeze-up of the shape-providing nozzle bores consists of reducing the mass flow rate of the cooling fluid, thereby causing less heat to be transferred to the perforated plate or to be removed from the perforated plate in the process of cross-flow heat exchange. However, if the air supply falls below a certain, critical air volume, the transport capacity of the incoming cooling fluid can be diminished sufficiently such that deposits of granules can take place, especially in the lower section of the housing, where the granules that come to rest next to one another shield each other from the cooling supply of coolant with the result that the surface of the granules heats up again, under the influence of a continuing inflow of heat, to over the temperature threshold above which the surface becomes sticky, which can have the subsequent result that granules adhere to one another and to the internal surfaces of the granulator, which can impede the production of granules or disrupt the production process.

The object of the invention is to create a simple, effective adjustability of the volume flow rate of the cooling fluid to a cutting chamber of a granulating device for feeding of both liquid and gaseous cooling fluid, for example water or process air.

The present embodiments meet this object.

### BRIEF DESCRIPTION OF THE DRAWINGS

The detailed description will be better understood in conjunction with the accompanying drawings as follows:

FIG. 1 shows a schematic, partially cross-sectional view of a granulating device for granulating melt material in a first embodiment of the invention.

FIG. 2 shows a schematic, partially cross-sectional view of a granulating device for granulating melt material in a second embodiment of the invention.

FIG. 3 shows a schematic, partially cross-sectional view of a granulating device for granulating melt material in a third embodiment of the invention.

FIG. 4 shows a schematic, partially cross-sectional view of a granulating device for granulating melt material in a fourth embodiment of the invention.

FIG. 5 shows a schematic, partially cross-sectional view of a granulating device for granulating melt material in a fifth embodiment of the invention.

FIG. 6 shows a schematic, partially cross-sectional view of a granulating device for granulating melt material in a sixth embodiment of the invention.

The present embodiments are detailed below with reference to the listed Figures.

### DETAILED DESCRIPTION OF THE EMBODIMENTS

Before explaining the present apparatus in detail, it is to be understood that the apparatus is not limited to the particular embodiments and that it can be practiced or carried out in various ways.

Specific structural and functional details disclosed herein are not to be interpreted as limiting, but merely as a basis of the claims and as a representative basis for teaching persons having ordinary skill in the art to variously employ the present invention.

The embodiments relate to a device for granulating melt material, for example from a material or material mixture with an active pharmaceutical ingredient or, for example a plastic melt material such as a polymer melt material. The material is granulated into pellets, such as for manufacturing pharmaceutical products from a corresponding melt material.

One embodiment of the invention concerns a device and a method for producing pellets from a melt material. The melt material can emerge from a perforated plate with nozzles located therein. The perforated plate can be located opposite a cutter arrangement having a cutter head with at least one blade, and can be driven by a cutter shaft connected to a motor. The at least one blade can pass over the nozzles in the perforated plate in a rotating manner and in so doing can cut pellets of the melt material emerging there.

The device can have a cutting chamber in a housing, which chamber can adjoin the perforated plate and enclose the at least one blade of the cutter arrangement. A coolant that can be introduced into the cutting chamber from an inlet apparatus flows through the cutting chamber. In the process, the pellets of the melt material can be solidified in the coolant. The inlet nozzle arrangement can be circumferentially enclosed by a separate inlet chamber in the area of rotation of the at least one blade. The inlet chamber can be arranged circumferentially around the cutting chamber such that the coolant can be introduced there into the cutting chamber circumferentially from different sides radially inward from the outside, or essentially radially inward from the outside. As a result, a centripetal or at least substantially centripetal flow of the coolant is produced in the area of rotation. Subsequently, the coolant and the pellets located therein can be conveyed to an outlet of the cutting chamber.

In the area of rotation, a second feed opening can be provided circumferentially, at least in sections, or multiple additional feed openings can be provided, for an additional flow of coolant to the cutting chamber. The second, additional feed opening(s) can have an orientation such that the additional flow of coolant differs from the flow of coolant entering through the second, additional inlet nozzle arrangement in at least one of the following parameters: physical state, direction, speed, pressure, temperature, density, throughput rate, and/or composition.

With this embodiment, a part of the housing, which is directly adjacent to a preferably annular gap that conveys for the purpose of cooling the perforated plate surface and granule surface and for the purpose of removing the created granules, can have an additional opening or an arrangement of openings connected to one another by a circumferential channel or another arrangement of openings for distributing suitably uniformly or adequately uniformly, that encompasses the totality of the housing circumference, at least in sections.

By means of this second, additional feed nozzle arrangement, a second cooling fluid quantity that is different from the first cooling fluid quantity encircling the perforated plate, directed at the hole circle, entering through the adjustable gap, can be made available for controlling the granulating process. In order to optimize the granulating process, the first and second cooling fluid quantities here can differ in physical state, direction, speed, pressure, temperature, density, throughput rate, and/or composition.

In this context, cooling fluid quantities having different physical states should be understood to mean that the first cooling fluid quantity can be, for example, coolant gases, while the second cooling fluid quantity can consist of cooling liquid, or vice versa. However, the first and second cooling fluid quantities can also be any combination of coolant liquids and coolant gases.

Cooling fluid quantities having different directions should be understood to mean that the feed nozzles of the first cooling fluid quantity are oriented differently than the feed nozzles of the second cooling fluid quantity with regard to the axis of rotation of the cutting blades and/or with regard to the radius of the cutting chamber.

A different speed with respect to the first and second cooling fluid quantities can, if the feed nozzles for the first and second cooling fluid quantities are of identical structure, be attributed to a different physical state, a different delivery pressure of the cooling fluid quantities and/or different temperatures, densities, and compositions of the cooling fluid quantities.

Different structures of the feed nozzles, such as narrower or wider nozzle openings and longer or shorter nozzle channels, can be used to further influence the delivery speed of the cooling fluid quantities. In addition, a different throughput rate of cooling fluid quantities should be understood to mean a different cooling fluid quantity per unit of time.

In particular, it can be accomplished by means of varying the first cooling fluid quantity, which emerges closer to the perforated plate. The melt stream exiting from the shape-providing nozzle bores of the perforated plate in a phase in which it has not yet been reduced to granules by the rotating blades, and thus potentially is encountering an opposing flow of a different and typically higher speed, is subjected to a cooling intensity that is matched to the local conditions. This matched cooling intensity makes it possible for the temperature level to be maintained that is necessary for the melt to flow into the shape-providing nozzle bores of the nozzle plate.

Nevertheless, a cooling and solidification of the granule surface can still be initiated this early, however. In the next process step, after cutting of a portion of the melt stream and formation into granules through the influence of the mass flow from the second, additional coolant feed apparatus, which provides a different temperature, quantity, density, and speed, the freshly formed granule, which, after a brief acceleration phase, typically moves away at a speed approaching the speed of the cooling fluid quantity surrounding it, and as a result can be subjected to a relatively low cooling intensity, can be carried away at a temperature that is useful both for suppressing a stickiness that complicates production and for further solidification, and at a speed that inhibits the creation of deposits that impede production.

In order to realize the above-mentioned advantages of a second coolant feed device, additional features of embodiments of the invention are discussed in detail below with respect to a novel granulating device.

Firstly it is proposed, as already mentioned above, for the first inlet nozzle arrangement to be implemented as an annular slot nozzle with an adjustable slot width, wherein adjustable vanes, rotatable plates, or other adjusting elements that govern the throughput through the annular slot nozzle are arranged in a prechamber of the annular slot nozzle, for example.

In another embodiment of the invention, the second, additional feed nozzle openings can also be made adjustable in a similar manner so that the one additional feed nozzle opening is implemented as an annular slot nozzle with an adjustable slot width. The adjustability of the slot width can preferably be achieved by two annular elements that are axially displaceable relative to one another, the annular slot nozzle being formed between them. When the annular elements are moved toward one another, the annular slot can be closed down to 0, and when the annular elements are moved apart, the slot width between the annular elements can be adjusted precisely and reproducibly.

In addition, provision can be made that the one or more additional second feed opening(s) is or are in fluid connection with an annular, circumferential channel, so that, with a uniformly distributed arrangement of openings over the circumference, a ring of feed openings is advantageously available that can be used and controlled independently of the first coolant feed device to optimize process flow. To this end, the openings can be implemented as bores or as slots oriented and delimited radially or axially or at a slant.

In another embodiment of the invention, provision can be made that a first inlet nozzle arrangement is located axially closer to the perforated plate than the one or more additional feed opening(s) of a second inlet nozzle arrangement. This is associated with the advantage that significantly improved control of the thermal balance of the perforated plate is possible in the region of the perforated plate, since the necessary fluid quantity for carrying away the cut granules can be taken care of independently by the second, additional inlet nozzle arrangement.

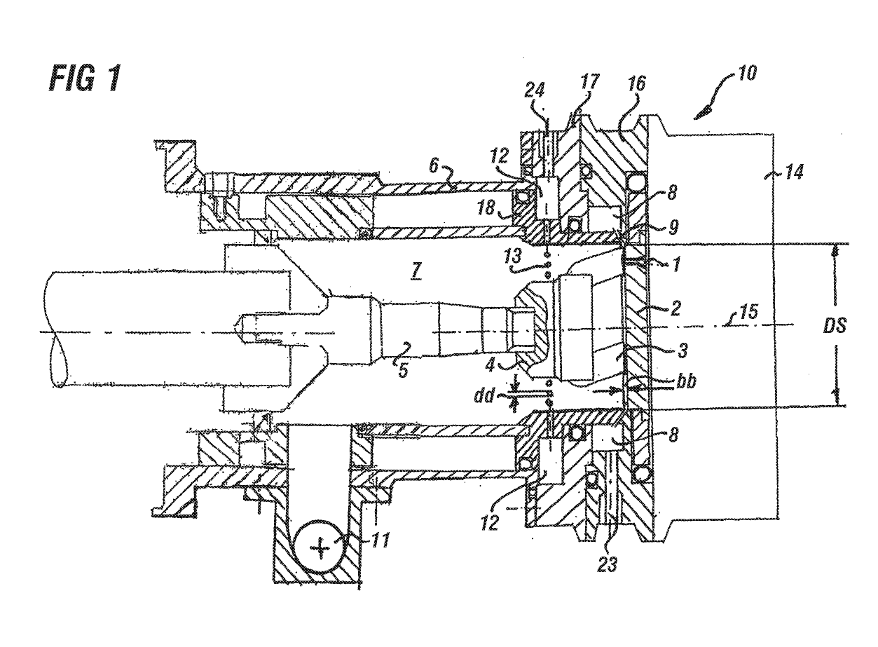

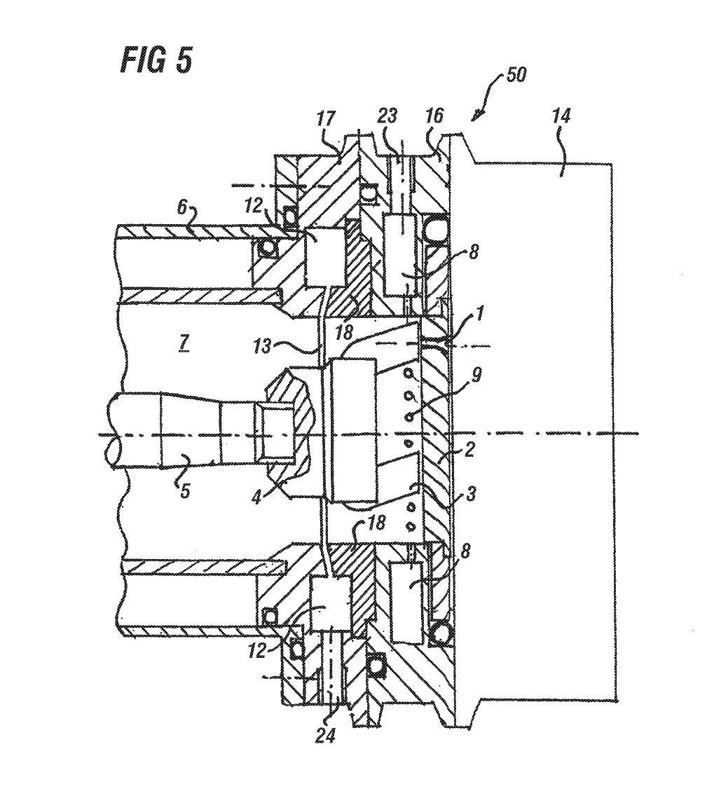

Alternatively, it is also possible that the one or the multiple second, additional feed nozzle opening(s) is/are located axially closer to the perforated plate than the first inlet nozzle arrangement. The attached FIGS. 1 and 5 show these alternative solutions by way of comparison. In these solutions, the one or more additional feed opening(s) are arranged in the region around the perforated plate and advantageously deploy a jet of cooling fluid that supports the release of the still-sticky granules from the blade edges.

Provision is made in another embodiment of the invention that the one or more additional feed opening(s) of the second, additional inlet nozzle arrangement is/are directed inward, radially parallel to the plane of the perforated plate, or is/are arranged to be inclined radially inward at an angle of up to 30° away from the plane of the perforated plate toward the cutting chamber. Due to the angle of up to 30° or of up to 60° relative to the axis of rotation of the cutter head, the transport and cooling fluid experiences an axial acceleration component in addition to the centripetal acceleration. This additional axial acceleration component advantageously forces the cooling fluid with the cut granules into a helically rotating flow direction as far as a tangentially oriented outlet, which improves the transport efficiency of the granules and increases the dwell time in the cutting chamber without wall contact.

Moreover, in place of additional nozzle openings oriented radially at the axis of rotation, it is additionally possible to provide a tangential component for a discharge direction of the additional nozzle openings at an angle from 90° and 60° with respect to a tangent to the wall of the cutting chamber, and thus to deviate from purely centripetal acceleration of the second coolant at 90° with respect to the tangent for the benefit of improved transport orientation of the granules in the coolant.

For a method according to the invention for producing pellets from a melt material, the following steps result. First the melt material can be extruded out through a perforated plate with nozzles located therein. As this is taking place, a cutter arrangement that can be located opposite the perforated plate and has at least one blade on a cutter head passes over the perforated plate in a rotating manner, wherein the blade can be driven by a cutter shaft that works together with a motor. In the process, the melt material can be cut by the at least one blade.

The strands of melt emerging from the nozzles of the perforated plate can be exposed to the rotating blade in a cutting chamber in a housing, while at the same time a coolant flows through the cutting chamber. This cooling fluid can be provided by a first inlet apparatus in order to solidify the surfaces of the cut granules. The coolant can be supplied from a first, separate inlet chamber that circumferentially encloses the cutting chamber in the area of rotation of the at least one blade.

The pellets of the melt material can be solidified in the coolant, at least on the surface. To this end, coolant can be introduced into the cutting chamber circumferentially from different sides radially inward from the outside, or essentially radially inward from the outside, wherein a centripetal or at least substantially centripetal flow of the coolant is produced at least in the area of rotation, and subsequently the coolant and the pellets located therein are conveyed to an outlet of the cutting chamber.

With a second, additional feed nozzle arrangement, which is arranged at a distance and separately from the first feed nozzle arrangement, an additional flow of coolant can be routed to the cutting chamber with an orientation such that the second, additional flow of coolant differs from the first flow of coolant by at least one of the following parameters: physical state, direction, speed, pressure, temperature, density, throughput rate, and/or composition.

The invention is described in detail below using the embodiments explained by way of example.

FIG. 1 shows a schematic, partially cross-sectional view of one embodiment of a granulating device 10 for granulating melt material in a first embodiment of the invention. Projecting from an extrusion head 14 for this purpose is a perforated plate 2 with nozzles 1, from which melt material can emerge, arranged therein in the shape of a circle. Located on the perforated plate 2 is a cutter arrangement having a cutter head 4 and with blades 3, wherein the cutter head 4 is driven by a cutter shaft 5 that works together with a motor which is not shown here. The blades on the rotating cutter head 4 are arranged such that they pass over the nozzles 1 in the perforated plate 2 in a rotating manner, and in doing so cut pellets of the melt material emerging there.

Such a granulating device 10 has a cutting chamber 7 in a housing 6 that adjoins the perforated plate 2. Toward the perforated plate, the housing 6 has annular elements 16, 17, and 18. The first annular element 16 is flange-mounted to the extrusion head 14 and an annular, first cavity, which serves as the first inlet chamber 8 for a cooling fluid that can flow in through a first inlet 23. Toward the perforated plate 2, the first inlet chamber 8 transitions into a first inlet nozzle arrangement 9, which in this case is designed as an annular slot nozzle and is oriented to the perforated plate 2 at an angle from 30° and 90°, such as at an angle of 45° as shown in FIG. 1, with respect to an axis 15 of the rotating cutter head 4, and thus makes possible a first intensive cooling of the cut granules directly after formation of the same by the blades 3 of the cutter head 4.

In order to better control the problems cited in the case of a granulation of melt material that is pressed through the nozzles 1 arranged in the shape of an annulus in the perforated plate 2 in the cutting chamber 7, the second annular element 17 has a second annular cavity in the form of a second inlet chamber 12, into which cooling fluid can flow through a second inlet 24 and flows through a second inlet nozzle arrangement 13 into the cutting chamber 7. The nozzle openings of the second inlet nozzle arrangement 13 are oriented radially in this first embodiment of the granulating device 10 according to FIG. 1, so that the granules pre-cooled directly during the cutting process by the first inlet nozzle arrangement 9 now ideally are centripetally accelerated toward the axis of rotation 15 of the rotating head 4, and thus are prevented from prematurely contacting the inner wall of the housing 6.

With the aid of the second inlet nozzle arrangement 13, the granules can thus be kept in the cooling fluid longer before they encounter the inner wall of the housing 6. Moreover, they continue to be cooled intensively by the turbulence arising as a result, and their capacity to stick is further reduced in advantageous fashion. As a result of the two independent cooling fluid flows, the first from the first inlet nozzle arrangement 9 and the second from the second inlet nozzle arrangement 13 arranged axially to the first inlet nozzle arrangement 9, control or regulation of the process control can be achieved by varying the physical state, direction, speed, pressure, temperature, density, throughput rate, and/or composition of the cooling fluid in the cutting chamber 7. In doing so, it can be advantageous if the outlet area FS of the annular gap nozzle of the first inlet nozzle arrangement 9, with an annular gap width b and an annular nozzle diameter DS, and the discharge area FD of the second inlet nozzle arrangement 13 consisting of individual nozzle bores with a nozzle diameter DD and a nozzle count n, both have approximately equal total discharge areas so that

$${F}_{D} = {F}_{S} . \\ With$$

$${F}_{D} = n \cdot {π ( \frac{{D}_{D}}{2} )}^{2}$$

$$And$$

$${F}_{S} = π \cdot {D}_{S} \cdot b$$

a value for the nozzle opening diameter DD for the second inlet nozzle arrangement 13 of

$${D}_{D} = 2 \sqrt{\frac{{D}_{S} \cdot b}{n}}$$

results, thus yielding, for example with a gap width b=1 mm and an annular gap diameter DS=32 mm, a nozzle diameter for the inlet nozzle openings of the second inlet nozzle arrangement 13 of 8 mm for a count of 2 second inlet nozzles, of 4 mm for a count of 8 second inlet nozzles, of approximately 2.28 mm for 24 second inlet nozzles, and of 3 mm for a count of 32 second inlet nozzles, which can be distributed about the circumference of the annular element 18.

If the gap width bb=1 mm is retained, but the diameter of the annular gap DS is increased to 64 mm, then for a total discharge area of equal size FS=FD (total of the individual nozzles), a diameter should be provided for a single second inlet nozzle of 8 mm for a count of 4 second inlet nozzles, or of 4 mm for 16 second inlet nozzles, and approximately 3.2 mm for 24 second inlet nozzles. However, if a predominant coolant flow should flow out of the second inlet nozzle arrangement 13 into the cutting chamber 7, then the annular element 18, for example, can be equipped with larger nozzle diameters DD so that a larger total discharge area results for the second inlet nozzle arrangement 13 as compared to the first inlet nozzle arrangement 9. On the other hand, it is also possible to configure the pressure of the coolant inflow to be different between the first inlet opening 23 and the second inlet opening 24, and thereby to regulate the difference in the coolant quantity. The cooling fluids of the first and second coolant inlet devices can also have different temperatures and different densities as well as different coolant compositions.

While the annular elements 16 and 17 determine the size of the annular inlet chambers 8 and 12, the gap widths bb and the diameter dd are determined by the design of the annular element 18. Thus the geometry of the first inlet nozzle arrangement 9 and of the second inlet nozzle arrangement 13 can be varied through the use of different annular elements 18.

Finally, the cutting chamber has an outlet 11 flange-mounted tangentially to the housing 6 that tangentially removes the rotating coolant flow enriched with granules from the granulating device 10. The rotation of the cooling fluid flow is substantially caused by the rotating blades. On the other hand, the rotation can be supported by appropriate orientation of the inlet nozzles of the second inlet nozzle arrangement 13 if they are equipped with an additional tangential component to their radial orientation shown in FIG. 1.

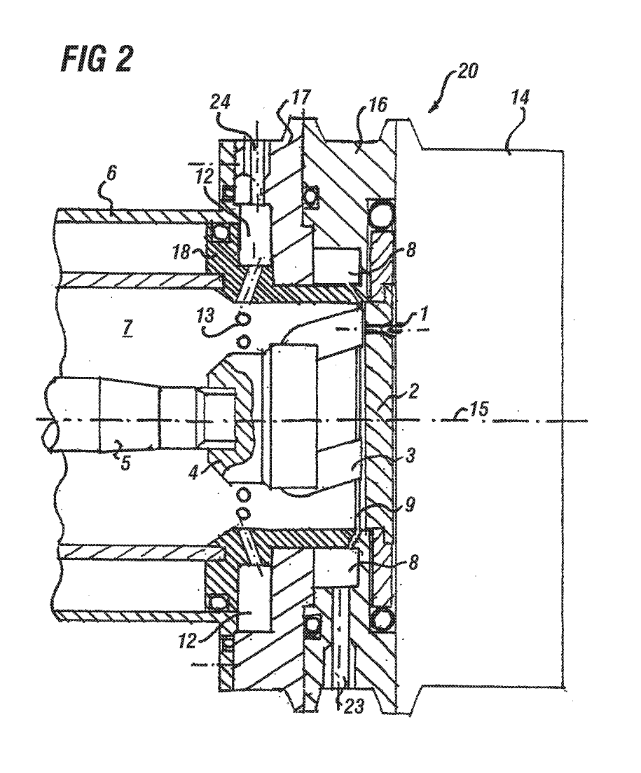

A second embodiment of a device for granulating melt material is shown with the granulating device 20 in FIG. 2. Components with the same functions as in FIG. 1 are labeled with the same reference characters in the figures that follow and are not discussed separately.

In FIG. 2, the orientation of the annular nozzle of the first inlet nozzle arrangement 9 is retained, and the orientation of the inlet nozzles of the additional second inlet nozzle arrangement is angled away from the perforated plate 2 by an angle of up to 30° with respect to the axis of rotation 15 from the radial orientation shown in FIG. 1, so that the centripetal acceleration of the cooling fluid flow is indeed retained to a reduced extent, but at the same time the cooling fluid flow is given an axial acceleration component, so that a fluid flow can be produced that flows helically toward the outlet 11 shown in FIG. 1.

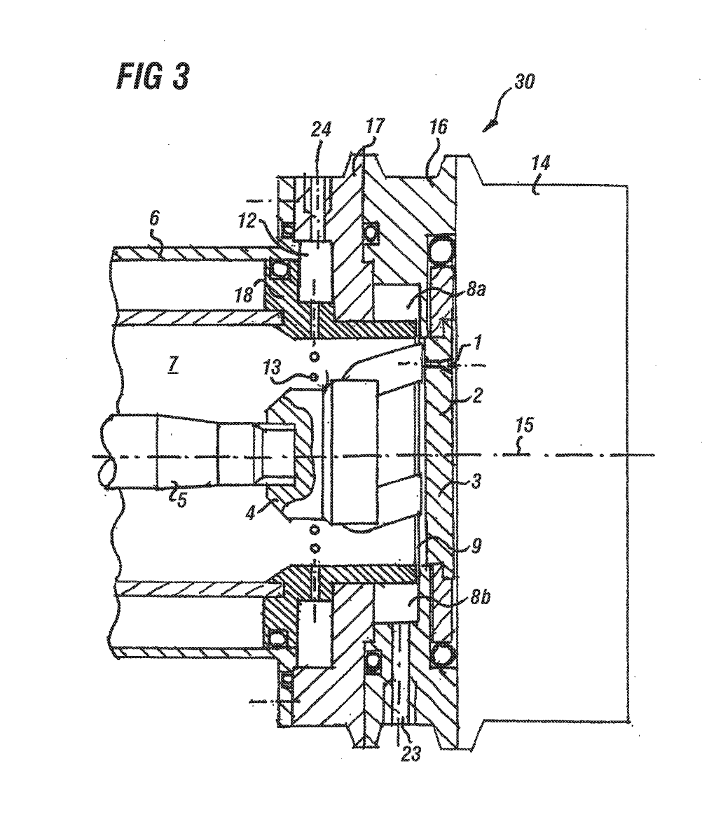

A third embodiment of the granulating device 30 of the invention is introduced with FIG. 3, in which the radial orientation of the additional second inlet nozzle arrangement 13 is retained, but the orientation of the annular gap of the first inlet nozzle arrangement 9 is now likewise restricted to a radial component. This can achieve the result that the effects of the cooling fluid on the perforated plate 2 are lessened, and consequently the risk of freeze-up of the melt material in the nozzles 1 of the perforated plate 2 is reduced, while at the same time the cooling effect of the cooling fluid on the cutting edges of the blades 3 of the cutter head 4 is enhanced. In this case, the design of both the annular element 18 and of the annular element 16 in the region of the first inlet nozzle arrangement 9 is adapted to the requirements of the radial orientation for a centripetal acceleration of the cooling fluid.

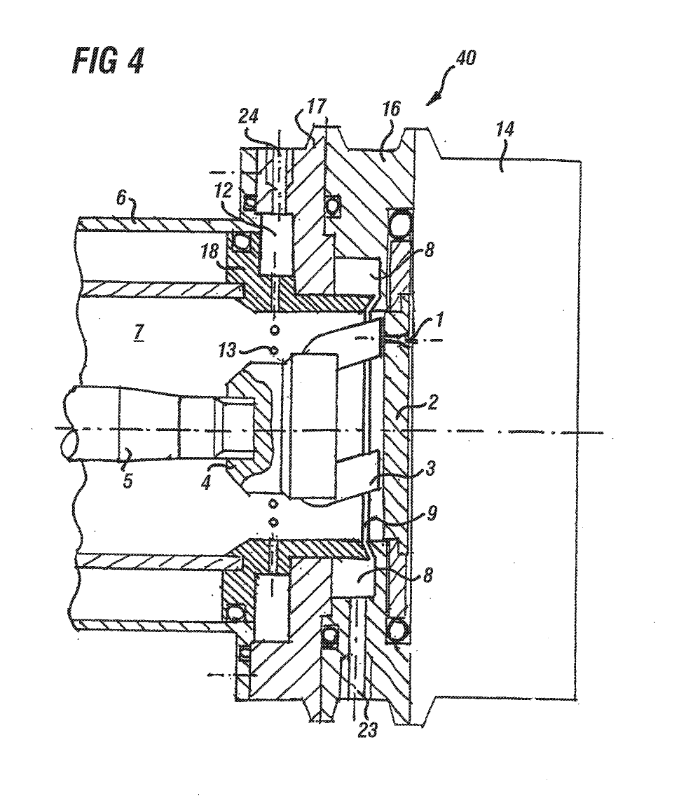

In FIG. 4, with a fourth embodiment of the invention, a granulating device 40 is presented that further varies the alignment of the first feed nozzle arrangement 9 in the form of an annular gap, and imparts to the first cooling fluid flow a clear axial component that is directed away from the perforated plate 2. Not only is the structure of the annular element 18 modified for this purpose, but also the contour of the annular element 16 must be adjusted in the region of the first feed nozzle arrangement 9.

In FIG. 5, another possibility is shown in the form of a fifth embodiment of a granulating device 50, in which the positions of an annular gap nozzle opening for the cooling fluid and the arrangement of nozzle bores of an inlet nozzle arrangement with respect to the perforated plate 2 are swapped. In addition, the arrangement of the annular elements 16, 17, and 18 relative to one another is modified. The annular element 18 is now fixed radially symmetrically between the annular elements 16 and 17, and now only influences the gap width b of an annular gap nozzle, which is now employed as second inlet nozzle arrangement 13 and at the same time has a flow orientation that provides an axial component in this fifth embodiment of a granulating device 50. The width of the annular gap nozzle can be adjusted to different process requirements by exchanging the annular element 18.

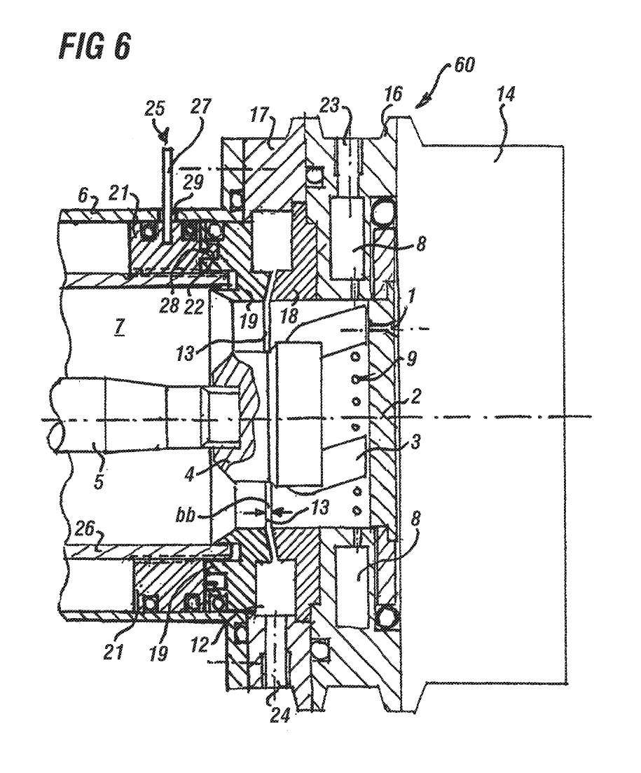

FIG. 6 introduces a granulating device 60 in which the arrangement of the first inlet nozzle arrangement 9 and of the second inlet nozzle arrangement 13 as in FIG. 5 are retained, but in addition an adjusting mechanism 25 that is accessible from the outside is provided, with which the gap width b of an annular gap nozzle for the second inlet nozzle arrangement 13 can be varied without the need to exchange the annular element 18 as FIG. 5 shows.

This adjusting mechanism 25 essentially has an additional annular element in the form of an adjusting ring 21 that has an internal thread which engages an external thread of an inside cylinder 26 of the housing 6. For this purpose, the housing 6 has an external adjusting slot 29 in which an adjusting arm 27 is located. The adjusting slot 29 allows a pivoting of the adjusting arm 27 for example up to 90° while rotating the adjusting ring 21 by a quarter turn, causing an annular element 19 to change the width b of the annular gap nozzle of the second inlet nozzle arrangement 13. A lug 28 couples the adjusting ring 21 with the annular element 19 in the form of a bayonet-type coupling 22, so that when the adjusting arm 27 is pivoted the gap width b can be reduced and/or enlarged while rotating the adjusting ring 21 with the aid of the coupled annular element 19.

Even though at least exemplary embodiments have been presented in the preceding description, various changes and modifications may be undertaken. The specified embodiments are merely examples and are not intended to restrict in any way the scope of application, the applicability, or the configuration of the granulating device. Instead, the above description provides a person skilled in the art with a plan for implementing at least one exemplary embodiment of the granulating device, wherein numerous changes may be made to the function and design of the granulating device in the components of the multi-part cooling fluid feed openings described in exemplary embodiments without departing from the scope of protection of the appended claims and their legal equivalents.

While the invention has been described with emphasis on the embodiments, it should be understood that within the scope of the appended claims, the embodiments might be practiced other than as specifically described herein.

What is claimed is:

1. A device for producing pellets from a melt material, comprising:
a) a perforated plate with nozzles from which the melt material emerges;
b) a cutter arrangement having a cutter head with at least one blade located opposite the perforated plate;
c) a cutter shaft driven by a motor connected to the cutter head configured such that the at least one blade passes over the nozzles in the perforated plate in a rotating manner to cut pellets of the melt material emerging therefrom;
d) a cutting chamber in a housing, wherein the cutting chamber adjoins the perforated plate and encloses the at least one blade of the cutter arrangement; and
e) a coolant that is introduced into the cutting chamber from an inlet apparatus, such that pellets of the melt material are solidified in the coolant, wherein the inlet apparatus has a separate inlet chamber that circumferentially encloses the cutting chamber in the area of rotation of the at least one blade and has an inlet nozzle arrangement located circumferentially around the cutting chamber between the inlet chamber and the cutting chamber so that the coolant can be introduced there into the cutting chamber essentially radially inward from the outside, wherein a centripetal or at least substantially centripetal flow of the coolant is produced at least in the area of rotation, and subsequently the coolant and the pellets located therein are conveyed to an outlet of the cutting chamber; and
wherein, one or more additional feed opening(s) are provided for an additional flow of the coolant to the cutting chamber, circumferentially at least in sections, with an orientation such that the additional flow of the coolant differs from the flow of the coolant entering through the inlet nozzle arrangement in at least one of the following parameters: physical state, direction, speed, pressure, temperature, density, throughput rate, and/or composition.

2. The device of claim 1, wherein the inlet nozzle arrangement is implemented as an annular slot nozzle with an adjustable slot width.

3. The device of claim 1, wherein the one or more additional feed opening(s) is/are implemented as an annular slot nozzle with an adjustable slot width.

4. The device of claim 1, wherein the one or more additional feed opening(s) is/are implemented as an annular, circumferential channel with an arrangement of openings in fluid connection that are uniformly distributed about the circumference, wherein the openings are implemented as bores, or as slots oriented and delimited radially, axially, or at a slant.

5. The device of claim 1, wherein the inlet nozzle arrangement is located axially closer to the perforated plate than the one or more additional feed opening(s).

6. The device of claim 1, wherein the one or more additional feed opening(s) is/are radially parallel to or spatially inclined to a plane of the perforated plate at an angle of up to 60° with respect to the axis of rotation of the cutter head and/or is/are arranged at an angle from 90° and 60° with respect to a tangential orientation to a wall of the cutting chamber.

7. A method for producing pellets from a melt material comprising:
a) emerging a melt material from a perforated plate with nozzles located therein;
b) cutting the melt material by a cutter arrangement located opposite the perforated plate and having a cutter head with at least one blade;
c) driving a cutter shaft connected to the cutter head with a motor, such that the at least one blade passes over the nozzles in the perforated plate in a rotating manner;
d) providing a cutting chamber in a housing, wherein the cutting chamber adjoins the perforated plate and encloses the at least one blade of the cutter arrangement;
e) flowing a coolant through the cutting chamber, wherein the coolant is introduced into the cutting chamber from an inlet apparatus, such that the pellets of the melt material are solidified in the coolant, wherein the inlet apparatus comprises:
i) an inlet chamber that circumferentially encloses the cutting chamber in the area of rotation of the at least one blade; and
ii) an inlet nozzle arrangement located circumferentially around the cutting chamber between the inlet chamber and the cutting chamber such that the coolant is introduced into the cutting chamber circumferentially from different sides essentially radially inward; and
wherein a substantially centripetal flow of the coolant is produced at least in the area of rotation, and subsequently the coolant and the pellets located therein are conveyed to an outlet of the cutting chamber;
f) providing at least one additional feed opening for an additional flow of coolant to the cutting chamber, wherein the additional feed opening is oriented such that the additional flow of coolant differs from a flow of coolant entering through the inlet nozzle arrangement in at least one of the following parameters: physical state, direction, speed, pressure, temperature, density, throughput rate, or composition.
